(19) United States
(12) Patent Application Publication
(10) Pub. No.: US 2003/0055651 A1
(43) Pub. Date: Mar. 20, 2003

(54) System, method and computer program product for extended element types to enhance operational characteristics in a voice portal

(76) Inventors: Ralf I. Pfeiffer, Santa Clara, CA (US); Laura A. Werner, Sunnyvale, CA (US)

Correspondence Address: BEVOCAL, INC., 685 CLYDE AVENUE, MOUNTAIN VIEW, CA, 94043-2213, US

(21) Appl. No.: 09/938,916

(22) Filed: Aug. 24, 2001

(51) Int. Cl. G10L 21/00; G10L 11/00

(52) U.S. Cl. 704/270.1

(57) ABSTRACT

A system, method and computer program product are provided for dynamically extending element types for a voice-based extensible mark-up language (VoiceXML). Initially, a plurality of element types are registered with a VoiceXML interpreter. In use, such registered element types are received during use of the VoiceXML interpreter. In response to such receipt, code associated with the registered element types is accessed utilizing the VoiceXML interpreter. Such code extends the functionality of the VoiceXML.

### FIELD OF THE INVENTION

The present invention relates to voice portals, and more particularly to the use of a voice extensible mark-up language in a voice portal.

### BACKGROUND OF THE INVENTION

Techniques for accomplishing automatic speech recognition (ASR) are well known. Among known ASR techniques are those that use grammars. A grammar is a representation of the language or phrases expected to be used or spoken in a given context. In one sense, then, ASR grammars typically constrain the speech recognizer to a vocabulary that is a subset of the universe of potentially-spoken words; and grammars may include subgrammars. An ASR grammar rule can then be used to represent the set of “phrases” or combinations of words from one or more grammars or subgrammars that may be expected in a given context. “Grammar” may also refer generally to a statistical language model (where a model represents phrases), such as those used in language understanding systems.

Products and services that utilize some form of automatic speech recognition (“ASR”) methodology have been recently introduced commercially. Desirable attributes of complex ASR services that would utilize such ASR technology include high accuracy in recognition; robustness to enable recognition where speakers have differing accents or dialects, and/or in the presence of background noise; ability to handle large vocabularies; and natural language understanding. In order to achieve these attributes for complex ASR services, ASR techniques and engines typically require computer-based systems having significant processing capability in order to achieve the desired speech recognition capability.

In a standard speech recognition/synthesis system, a database of utterances is maintained for administering a predetermined service. In one example of operation, a user may utilize a telecommunication network to communicate utterances to the system. In response to such communication, the utterances are recognized utilizing speech recognition, and processing takes place utilizing the recognized utterances. Thereafter, synthesized speech is outputted in accordance with the processing. In one particular application, a user may verbally communicate a street address to the speech recognition system, and driving directions may be returned utilizing synthesized speech.

In order to facilitate the interaction between the user and a system that is available through the Internet, a specially adapted voice mark-up language (VoiceXML) is employed. VoiceXML allows for the creation of voice dialogs, which are stored on any Web site and referenced by URL just like HTML documents. In use, the user may call a phone number and interact with a VoiceXML application through speech recognition, and (TTS) Text-To-Speech and recorded prompts. To accomplish this, VoiceXML allows a developer to create a script, whereby the user can have a conversation with a script which is stored on the Web site, and executed by a VoiceXML Browser. The user places a call and is connected to a program called a voice browser, or “interpreter”. The voice browser will fetch the user's VoiceXML document at a specified URL. The user will interact with the VoiceXML document using speech recognition as it is interpreted by the VoiceXML Browser. The markup defined in VoiceXML is a specific instance of the Extensible Markup Language (XML), the strategic data definition language for the Internet.

VoiceXML offers a standard format in which developers can create voice dialog with a Web site. Unfortunately, such standard is often limiting in the functionality that it provides. As such, there is thus a need for extending VoiceXML functionality in the context of a speech recognition/synthesis system.

### DISCLOSURE OF THE INVENTION

A system, method and computer program product are provided for dynamically extending element types for a voice-based extensible mark-up language (VoiceXML). Initially, a plurality of element types are registered with a VoiceXML interpreter. In use, such registered element types are received during use of the VoiceXML interpreter. In response to such receipt, code associated with the registered element types is accessed utilizing the VoiceXML interpreter. Such code extends the functionality of the VoiceXML.

In one embodiment, the code is written in JAVA. Of course, other computer languages may be used per the desires of the developer.

In another embodiment, the registration may include tagging the registered element types as being extensions to a conventional set of element types. Further, the element types may be tagged utilizing extensible mark-up language (XML) namespaces. Still yet, the registration may further include identifying a VoiceXML element type to be extended, along with a name for the to-be-extended VoiceXML element type. Thereafter, the registration includes identifying a class to be loaded for the VoiceXML element type to be extended, and a location of a file containing class files associated with the identified class.

A system, method and computer program product are also provided for dynamically extending a type attribute of elements of a voice-based extensible mark-up language (VoiceXML). Initially, an extended type attribute associated with an element of VoiceXML is registered with a VoiceXML interpreter. During use, the element may be received, and the extended type attribute associated with the element is identified. Thereafter, code corresponding to the registered type attribute may be accessed utilizing the VoiceXML interpreter. Such code extends the functionality of the VoiceXML.

As such, a data structure is provided for dynamically extending a type attribute of elements of a VoiceXML. First provided is a VoiceXML type attribute object that is extended to include a previously undefined type attribute. Also included is a VoiceXML element. Associated therewith is a class object for identifying a class to be loaded for the VoiceXML type attribute object that is extended. In use, the data structure is capable of being used to register type attributes capable of accessing code to extend the functionality of the VoiceXML.

The present embodiment thus provides a basic technique of modifying or adding to a mapping between VoiceXML tag names and Java classes which implement those tags. The interpreter looks at this mapping to discover which classes should be used to implement a specific tag.

The present embodiment further provides a syntax by which this extension of tags may be accomplished utilizing VoiceXML. This allows a VoiceXML developer to specify the extension and classes which should be used.

### BRIEF DESCRIPTION OF THE DRAWINGS

FIG. 1 illustrates an exemplary environment in which the present invention may be implemented;

FIG. 2 shows a representative hardware environment associated with the various components of FIG. 1;

FIG. 3 illustrates a method for providing a speech recognition process utilizing the utterances collected during the method of FIG. 3;

FIG. 4 illustrates a web-based interface which interacts with a database to enable and coordinate an audio transcription effort;

FIG. 5 is a schematic illustrating the manner in which VoiceXML functions, in accordance with one embodiment of the present invention; and

FIG. 6 illustrates a method of dynamically extending element types for VoiceXML.

### DESCRIPTION OF THE PREFERRED EMBODIMENTS

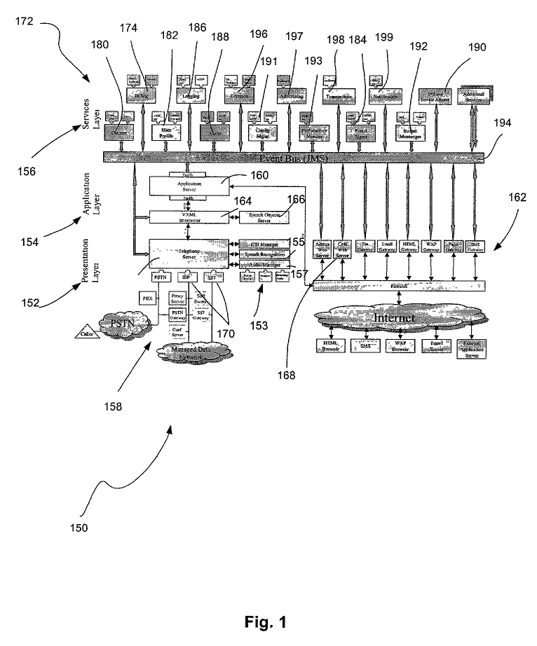

FIG. 1 illustrates one exemplary platform 150 on which the present invention may be implemented. The present platform 150 is capable of supporting voice applications that provide unique business services. Such voice applications may be adapted for consumer services or internal applications for employee productivity.

The present platform of FIG. 1 provides an end-to-end solution that manages a presentation layer 152, application logic 154, information access services 156, and telecom infrastructure 159. With the instant platform, customers can build complex voice applications through a suite of customized applications and a rich development tool set on an application server 160. The present platform 150 is capable of deploying applications in a reliable, scalable manner, and maintaining the entire system through monitoring tools.

The present platform 150 is multi-modal in that it facilitates information delivery via multiple mechanisms 162, i.e. Voice, Wireless Application Protocol (WAP), Hypertext Mark-up Language (HTML), Facsimile, Electronic Mail, Pager, and Short Message Service (SMS). It further includes a VoiceXML interpreter 164 that is fully compliant with the VoiceXML 1.0 specification, written entirely in Java®, and supports Nuance® SpeechObjects 166.

Yet another feature of the present platform 150 is its modular architecture, enabling “plug-and-play” capabilities. Still yet, the instant platform 150 is extensible in that developers can create their own custom services to extend the platform 150. For further versatility, Java® based components are supported that enable rapid development, reliability, and portability. Another web server 168 supports a web-based development environment that provides a comprehensive set of tools and resources which developers may need to create their own innovative speech applications.

Support for SIP and SS7 (Signaling System 7) is also provided. Backend Services 172 are also included that provide value added functionality such as content management 180 and user profile management 182. Still yet, there is support for external billing engines 174 and integration of leading edge technologies from Nuance®, Oracle®, Cisco®, Natural Microsystems®, and Sun Microsystems®.

More information will now be set forth regarding the application layer 154, presentation layer 152, and services layer 156.

Application Layer (154)

The application layer 154 provides a set of reusable application components as well as the software engine for their execution. Through this layer, applications benefit from a reliable, scalable, and high performing operating environment. The application server 160 automatically handles lower level details such as system management, communications, monitoring, scheduling, logging, and load balancing. Some optional features associated with each of the various components of the application layer 154 will now be set forth.

Application Server (160)

A high performance web/JSP server that hosts the business and presentation logic of applications.

High performance, load balanced, with failover.

Contains reusable application components and ready to use applications.

Hosts Java Servlets and JSP's for custom applications.

Provides easy to use taglib access to platform services.

VoiceXML Interpreter (164)

Executes VoiceXML applications

VoiceXML 1.0 compliant

Can execute applications hosted on either side of the firewall.

Extensions for easy access to system services such as billing.

Extensible—allows installation of custom VoiceXML tag libraries and speech objects.

Provides access to SpeechObjects 166 from VoiceXML.

Integrated with debugging and monitoring tools.

Written in Java®.

Speech Objects Server (166)

Hosts SpeechObjects based components.

Provides a platform for running SpeechObjects based applications.

Contains a rich library of reusable SpeechObjects.

Services Layer (156)

The services layer 156 simplifies the development of voice applications by providing access to modular value-added services. These backend modules deliver a complete set of functionality, and handle low level processing such as error checking. Examples of services include the content 180, user profile 182, billing 174, and portal management 184 services. By this design, developers can create high performing, enterprise applications without complex programming. Some optional features associated with each of the various components of the services layer 156 will now be set forth.

Content (180)

Manages content feeds and databases such as weather reports, stock quotes, and sports.

Ensures content is received and processed appropriately.

Provides content only upon authenticated request.

Communicates with logging service 186 to track content usage for auditing purposes.

Supports multiple, redundant content feeds with automatic failover.

Sends alarms through alarm service 188.

User Profile (182)

Manages user database

Can connect to a 3^{rd} party user database 190. For example, if a customer wants to leverage his/her own user database, this service will manage the connection to the external user database.

Provides user information upon authenticated request.

Alarm (188)

Provides a simple, uniform way for system components to report a wide variety of alarms.

Allows for notification (Simply Network Management Protocol (SNMP), telephone, electronic mail, pager, facsimile, SMS, WAP push, etc.) based on alarm conditions.

Allows for alarm management (assignment, status tracking, etc) and integration with trouble ticketing and/or helpdesk systems.

Allows for integration of alarms into customer premise environments.

Configuration Management (191)

Maintains the configuration of the entire system.

Performance Monitor (193)

Provides real time monitoring of entire system such as number of simultaneous users per customer, number of users in a given application, and the uptime of the system.

Enables customers to determine performance of system at any instance.

Portal Management (184)

The portal management service 184 maintains information on the configuration of each voice portal and enables customers to electronically administer their voice portal through the administration web site.

Portals can be highly customized by choosing from multiple applications and voices. For example, a customer can configure different packages of applications i.e. a basic package consisting of 3 applications for $4.95, a deluxe package consisting of 10 applications for $9.95, and premium package consisting of any 20 applications for $14.95.

Instant Messenger (192)

Detects when users are “on-line” and can pass messages such as new voicemails and e-mails to these users.

Billing (174)

Provides billing infrastructure such as capturing and processing billable events, rating, and interfaces to external billing systems.

Logging (186)

Logs all events sent over the JMS bus 194. Examples include User A of Company ABC accessed Stock Quotes, application server 160 requested driving directions from content service 180, etc.

Location (196)

Provides geographic location of caller.

Location service sends a request to the wireless carrier or to a location network service provider such as TimesThree® or US Wireless. The network provider responds with the geographic location (accurate within 75 meters) of the cell phone caller.

Advertising (197)

Administers the insertion of advertisements within each call. The advertising service can deliver targeted ads based on user profile information.

Interfaces to external advertising services such as Wyndwire® are provided.

Transactions (198)

Provides transaction infrastructure such as shopping cart, tax and shipping calculations, and interfaces to external payment systems.

Notification (199)

Provides external and internal notifications based on a timer or on external events such as stock price movements. For example, a user can request that he/she receive a telephone call every day at 8AM.

Services can request that they receive a notification to perform an action at a pre-determined time. For example, the content service 180 can request that it receive an instruction every night to archive old content.

3^{rd} Party Service Adapter (190)

Enables 3^{rd} parties to develop and use their own external services. For instance, if a customer wants to leverage a proprietary system, the 3^{rd} party service adapter can enable it as a service that is available to applications.

Presentation Layer (152)

The presentation layer 152 provides the mechanism for communicating with the end user. While the application layer 154 manages the application logic, the presentation layer 152 translates the core logic into a medium that a user's device can understand. Thus, the presentation layer 152 enables multi-modal support. For instance, end users can interact with the platform through a telephone, WAP session, HTML session, pager, SMS, facsimile, and electronic mail. Furthermore, as new “touchpoints” emerge, additional modules can seamlessly be integrated into the presentation layer 152 to support them.

Telephony Server (158)

The telephony server 158 provides the interface between the telephony world, both Voice over Internet Protocol (VoIP) and Public Switched Telephone Network (PSTN), and the applications running on the platform. It also provides the interface to speech recognition and synthesis engines 153. Through the telephony server 158, one can interface to other 3^{rd} party application servers 190 such as unified messaging and conferencing server. The telephony server 158 connects to the telephony switches and “handles” the phone call.

Features of the telephony server 158 include:

Mission critical reliability.

Suite of operations and maintenance tools.

Telephony connectivity via ISDN/T1/E1, SIP and SS7 protocols.

DSP-based telephony boards offload the host, providing real-time echo cancellation, DTMF & call progress detection, and audio compression/decompression.

Speech Recognition Server (155)

The speech recognition server 155 performs speech recognition on real time voice streams from the telephony server 158. The speech recognition server 155 may support the following features:

Carrier grade scalability & reliability

Large vocabulary size

Industry leading speaker independent recognition accuracy

Recognition enhancements for wireless and hands free callers

Dynamic grammar support—grammars can be added during run time.

Multi-language support

Barge in—enables users to interrupt voice applications. For example, if a user hears “Please say a name of a football team that you,” the user can interject by saying “Miami Dolphins” before the system finishes.

Speech objects provide easy to use reusable components

“On the fly” grammar updates

Speaker verification

Audio Manager (157)

Manages the prompt server, text-to-speech server, and streaming audio.

Prompt Server (153)

The Prompt server is responsible for caching and managing pre-recorded audio files for a pool of telephony servers.

Text-to-Speech Server (153)

When pre-recorded prompts are unavailable, the text-to-speech server is responsible for transforming text input into audio output that can be streamed to callers on the telephony server 158. The use of the TTS server offloads the telephony server 158 and allows pools of TTS resources to be shared across several telephony servers. Features include:

Support for industry leading technologies such as SpeechWorks® Speechify® and L&H RealSpeak®.

Standard Application Program Interface (API) for integration of other TTS engines.

Streaming Audio

The streaming audio server enables static and dynamic audio files to be played to the caller. For instance, a one minute audio news feed would be handled by the streaming audio server.

Support for standard static file formats such as WAV and MP3

Support for streaming (dynamic) file formats such as Real Audio® and Windows® Media®.

PSTN Connectivity

Support for standard telephony protocols like ISDN, E&M WinkStart®, and various flavors of E1 allow the telephony server 158 to connect to a PBX or local central office.

SIP Connectivity

The platform supports telephony signaling via the Session Initiation Protocol (SIP). The SIP signaling is independent of the audio stream, which is typically provided as a G.711 RTP stream. The use of a SIP enabled network can be used to provide many powerful features including:

Flexible call routing

Call forwarding

Blind & supervised transfers

Location/presence services

Interoperable with SIP compliant devices such as soft switches

Direct connectivity to SIP enabled carriers and networks

Connection to SS7 and standard telephony networks (via gateways)

Admin Web Server

Serves as the primary interface for customers.

Enables portal management services and provides billing and simple reporting information. It also permits customers to enter problem ticket orders, modify application content such as advertisements, and perform other value added functions.

Consists of a website with backend logic tied to the services and application layers. Access to the site is limited to those with a valid user id and password and to those coming from a registered IP address. Once logged in, customers are presented with a homepage that provides access to all available customer resources.

Other (168)

Web-based development environment that provides all the tools and resources developers need to create their own speech applications.

Provides a VoiceXML Interpreter that is:

Compliant with the VoiceXML 1.0 specification.

Compatible with compelling, location-relevant SpeechObjects—including grammars for nationwide US street addresses.

Provides unique tools that are critical to speech application development such as a vocal player. The vocal player addresses usability testing by giving developers convenient access to audio files of real user interactions with their speech applications. This provides an invaluable feedback loop for improving dialogue design.

WAP, HTML, SMS, Email, Pager, and Fax Gateways

Provide access to external browsing devices.

Manage (establish, maintain, and terminate) connections to external browsing and output devices.

Encapsulate the details of communicating with external device.

Support both input and output on media where appropriate. For instance, both input from and output to WAP devices.

Reliably deliver content and notifications.

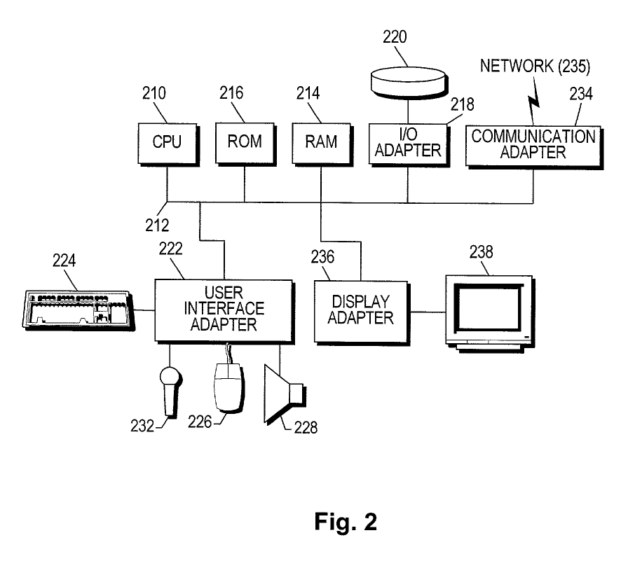

FIG. 2 shows a representative hardware environment associated with the various systems, i.e. computers, servers, etc., of FIG. 1. FIG. 2 illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network (e.g., a data processing network) and a display adapter 236 for connecting the bus 212 to a display device 238. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

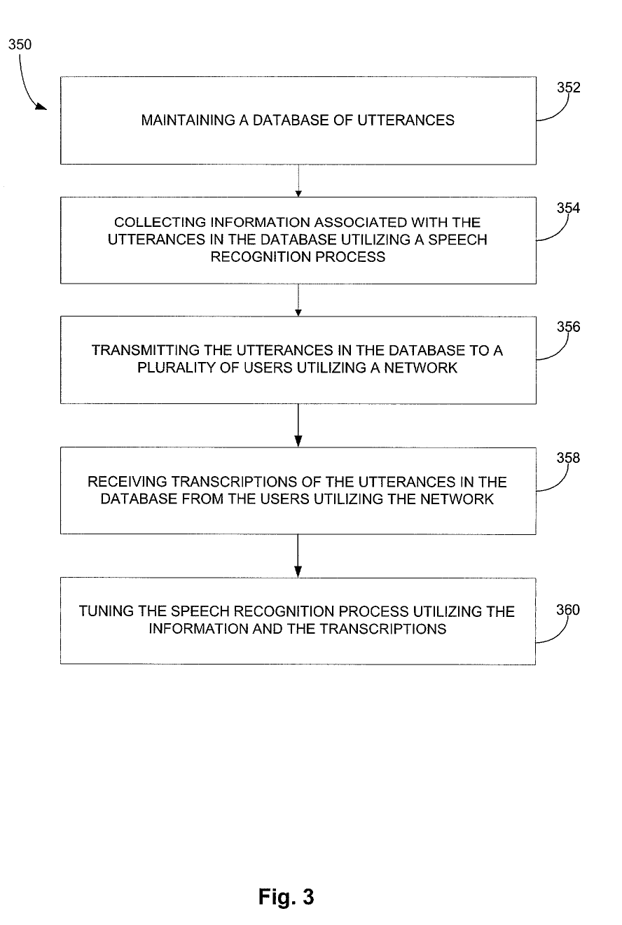

FIG. 3 illustrates a method 350 for providing a speech recognition process utilizing the utterances collected during use of a voice portal. Initially, a database of the collected utterances is maintained. See operation 352. In operation 354, information associated with the utterances is collected utilizing a speech recognition process. When a speech recognition process application is deployed, audio data and recognition logs may be created. Such data and logs may also be created by simply parsing through the database at any desired time.

In one embodiment, a database record may be created for each utterance. Table 1 illustrates the various information that the record may include.

TABLE 1

Name of the grammar it was recognized against;
Name of the audio file on disk;
Directory path to that audio file;
Size of the file (which in turn can be used to calculate the length
of the utterance if the sampling rate is fixed);
Session identifier;
Index of the utterance (i.e. the number of utterances said before in
the same session);
Dialog state (identifier indicating context in the dialog flow in
which recognition happened);
Recognition status (i.e. what the recognizer did with the utterance
(rejected, recognized, recognizer was too slow);
Recognition confidence associated with the recognition result;
Recognition hypothesis;
Gender of the speaker;
Identification of the transcriber; and/or
Date the utterances were transcribed.

Inserting utterances and associated information in this fashion in the database (SQL database) allows instant visibility into the data collected. Table 2 illustrates the variety of information that may be obtained through simple queries.

TABLE 2

Number of collected utterances;
Percentage of rejected utterances for a given grammar;
Average length of an utterance;
Call volume in a give data range;
Popularity of a given grammar or dialog state; and/or
Transcription management (i.e. transcriber's productivity).

Further, in operation 356, the utterances in the database are transmitted to a plurality of users utilizing a network. As such, transcriptions of the utterances in the database may be received from the users utilizing the network. Note operation 358. As an option, the transcriptions of the utterances may be received from the users using a network browser.

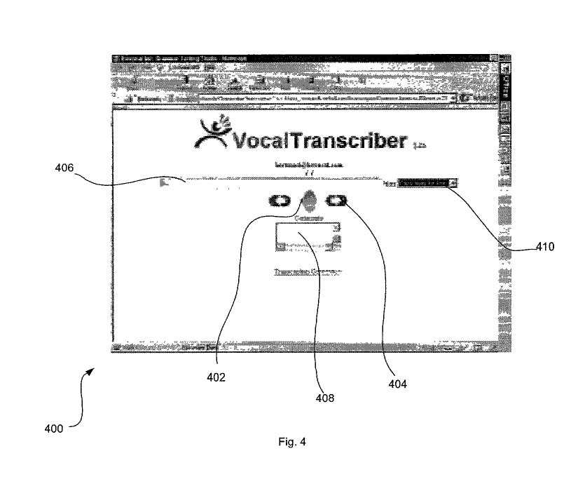

FIG. 4 illustrates a web-based interface 400 that may be used which interacts with the database to enable and coordinate the audio transcription effort. As shown, a speaker icon 402 is adapted for emitting a present utterance upon the selection thereof. Previous and next utterances may be queued up using selection icons 404. Upon the utterance being emitted, a local or remote user may enter a string corresponding to the utterance in a string field 406. Further, comments (re. transcriber's performance) may be entered regarding the transcription using a comment field 408. Such comments may be stored for facilitating the tuning effort, as will soon become apparent.

As an option, the web-based interface 400 may include a hint pull down menu 410. Such hint pull down menu 410 allows a user choose from a plurality of strings identified by the speech recognition process. This allows the transcriber to do a manual comparison between the utterance and the results of the speech recognition process. Comments regarding this analysis may also be entered in the comment field 408.

The web-based interface 400 thus allows anyone with a web-browser and a network connection to contribute to the tuning effort. During use, the interface 400 is capable of playing collected sound files to the authenticated user, and allows them to type into the browser what they hear. Making the transcription task remote simplifies the task of obtaining quality transcriptions of location specific audio data (street names, city names, landmarks). The order in which the utterances are fed to the transcribers can be tweaked by a transcription administrator (e.g. to favor certain grammars, or more recently collected utterances). This allows for the transcribers work to be focused on the areas needed.

Similar to the speech recognition process of operation 304 of FIG. 3, the present interface 400 of FIG. 4 and the transcription process contribute information for use during subsequent tuning. Table 3 illustrates various fields of information that may be associated with each utterance record in the database.

TABLE 3

Date the utterance was transcribed;
Identifier of the transcriber;
Transcription text;
Transcription comments noting speech anomalies;
and/or
Gender identifier.

During operation, the database of utterances collected and maintained during the methods of FIG. 3 may be used to provide various services. Examples of various specific voice portal applications are set forth in Table 4. It should be noted that any services may be afforded per the desires of the user.

TABLE 4
Nationwide Business Finder—search engine for locating businesses
representing popular brands demanded by mobile consumers.
Nationwide Driving Directions—point-to-point driving directions
Worldwide Flight Information—up-to-the-minute flight
information on major domestic and international carriers
News—audio feeds providing the latest national and world headlines,
as well as regular updates for business, technology, finance, sports,
health and entertainment news
Sports—up-to-the-minute scores and highlights from the NFL, Major
League Baseball, NHL, NBA, college football, basketball, hockey,
tennis, auto racing, golf, soccer and boxing
Stock Quotes—access to major indices and all stocks on the NYSE,
NASDAQ, and AMEX exchanges
Infotainment—updates on soap operas, television dramas, lottery
numbers and horoscopes

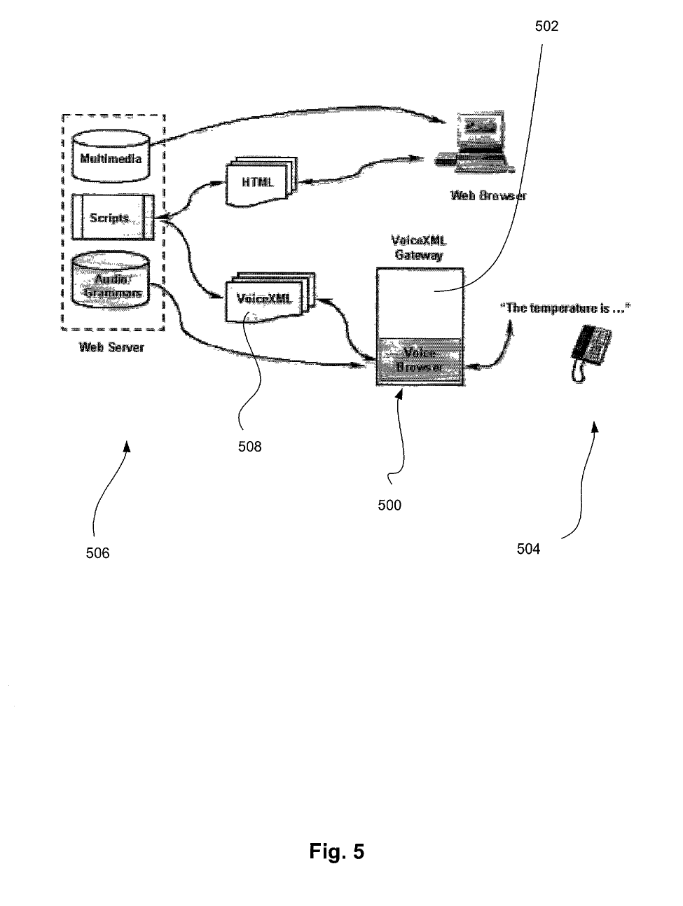

FIG. 5 is a schematic illustrating the manner in which VoiceXML functions in the context of the aforementioned architecture to support a voice portal that provides services such as those of Table 4. As shown, a typical VoiceXML interpreter 500 runs on a specialized voice gateway node 502 that is connected both to the public switched telephone network 504 and to the Internet 506. As shown, VoiceXML 508 acts as an interface between the voice gateway node 502 and the Internet 506.

VoiceXML takes Advantage of Several Trends:

The growth of the World-Wide Web and of its capabilities.

Improvements in computer-based speech recognition and text-to-speech synthesis.

The spread of the WWW beyond the desktop computer.

Voice application development is easier because VoiceXML is a high-level, domain-specific markup language, and because voice applications can now be constructed with plentiful, inexpensive, and powerful web application development tools.

VoiceXML is based on XML. XML is a general and highly flexible representation of any type of data, and various transformation technologies make it easy to map one XML structure to another, or to map XML into other data formats.

VoiceXML is an extensible markup language (XML) for the creation of automated speech recognition (ASR) and interactive voice response (IVR) applications. Based on the XML tag/attribute format, the VoiceXML syntax involves enclosing instructions (items) within a tag structure in the following manner:

<element_name attribute_name=“attribute_value”>

. . . . . . contained items . . . . . .

</element_name>

A VoiceXML application consists of one or more text files called documents. These document files are denoted by a “.vxml” file extension and contain the various VoiceXML instructions for the application. It is recommended that the first instruction in any document to be seen by the interpreter be the XML version tag:

<?xml version=“1.0”?>

The remainder of the document's instructions should be enclosed by the vxml tag with the version attribute set equal to the version of VoiceXML being used (“1.0” in the present case) as follows:

<vxml version=“1.0”>

Inside of the <vxml> tag, a document is broken up into discrete dialog elements.

Each element has a name and is responsible for executing some portion of the dialog. An element is denoted by the use of the <element> tag. Table 5 illustrates an exemplary list of element types available in one specification of VoiceXML.

TABLE 5
element types:

<field>-gathers input from the user via speech or DTMF
recognition as defined by a grammar
<record>-records an audio clip from the user
<transfer>-transfers the user to another phone number
<object>-invokes a platform-specific object that may
gather user input, returning the result as an ECMAScript
object
<subdialog>-performs a call to another dialog or
document(similar to a function call), returning the
result as an ECMAScript object

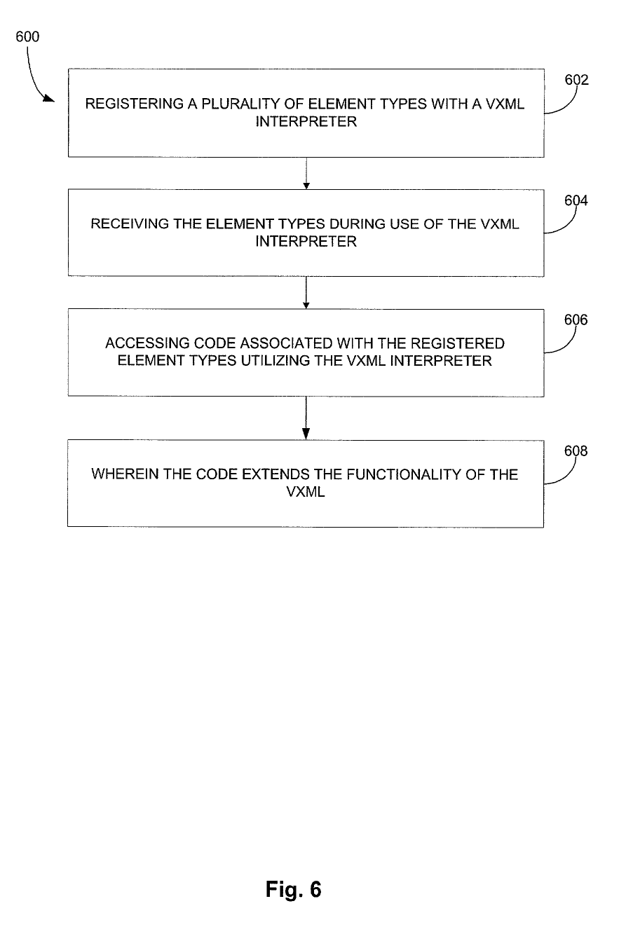

FIG. 6 illustrates a method 600 of dynamically extending element types for VoiceXML. Initially, in operation 602, a plurality of element types are registered with a VoiceXML interpreter. In one embodiment, the element types may be extended using JAVA. Of course, other computer languages may be used per the desires of the developer.

The registration process includes using a predetermined data structure to extend VoiceXML functionality in the VoiceXML interpreter. In one embodiment, such data structure may include a VoiceXML element type (i.e. element) to be extended, a name (i.e. type) for the VoiceXML element type to be extended, a class (i.e. classid) to be loaded for the VoiceXML element type to be extended, and a location (i.e. archive) of a file containing class files associated with the identified class. Table 6 summarizes definitions of the aforementioned element, type, classid, and archive.

TABLE 6

| | |
|---|---|
| element | VoiceXML that developer wants to extend. |
| type | name of the new type being declared. |
| classid | fully-qualified name of the Java class to be loaded. |
| archive | A Jar archive containing the Java class files for |
| | classid and any other classes it requires. |

The class referred to by classid in Table 6 extends the abstract class like the one in Table 7, and implements its abstract methods. Table 7 is an example for the case in which the element being extended is “field.”

TABLE 7
package bevocal.vxml.extensions;
public abstract class FieldType {

| | | |
|---|---|---|
| abstract | FieldGrammar | getGrammar(String type, Map params); |
| | boolean | validate(String result) { return true; } |

protected static class FieldGrammar {

public FieldGrammar(String mimeType, String grammar);
public final String getMimeType( );
public final String getGrammarString( );

};

};

More information will now be set forth regarding the methods, getGrammar and validate, shown in Table 7. It is important to note that the foregoing is merely an example of extending a <field> element.

GetGrammar

The getGrammar method shown in Table 7 is called when the VoiceXML document containing the extended element type is parsed. It may return an FieldGrammar object containing a string representation of the grammar for the extended element type, along with the MIME type of the grammar. Additional grammar types may also be supported. The type argument to getGrammar indicates the type of extended element being created, which allows one to use the same Java class to implement several different extended element types. The params argument is a map containing any parameters used on the element type. For example, if the type were “duration?increment=15”, type would be “duration”, and params would contain the single key/value pair {“increment”, “15”}.

Validate

The validate method shown in Table 7 is called after the interpreter has recognized an utterance that matches the grammar returned by the getGrammar method, but before the element type variable is set and the <filled> blocks are executed. The present method performs post-processing to make sure that the value is within the accepted range for this element; its argument is the string value that corresponds to the user's utterance. If the potential result is not valid, validate returns false, which causes a nomatch event to be issued.

Ideally, an element's grammar does not accept any utterances that aren't valid for the element. However, sometimes it is difficult to construct a grammar that can filter out all invalid responses, and the validate method provides one with an additional degree of flexibility in those cases. If one does not override validate, it will return true by default, meaning that all utterances that match the element's grammar are valid.

Namespaces

In a preferred embodiment, the registration operation 602 further includes tagging the registered element types as being extensions to a conventional set of element types. In one embodiment, the element types may be tagged utilizing extensible mark-up language (XML) namespaces. This is to ensure that the tag name does not conflict with any tags that are added to VoiceXML in the future.

A namespace refers to a document at a specific Web site that identifies the names of particular data elements or attributes used within the XML file. The XML file creator identifies the namespace by specifying its Web address (URL) near the beginning of the XML file. A XML parser, usually provided as part of a Web browser, then knows where to find the rules for displaying and other information about each element in the XML file.

In use, the registered element types are received during use of the VoiceXML interpreter. Note operation 604. Such registered element types are identified by the aforementioned tagging. In response to such receipt, in operation 606, code associated with the registered element types is accessed utilizing the VoiceXML interpreter. Such code serves to extend the functionality of the VoiceXML, as indicated in operation 608. It should be noted that grammar extensions may also be employed per the desires of the user.

JAVA implementation

As mentioned earlier, the code may be written in JAVA. JAVA solves many of the client-side problems by:

Improving performance on the client side;

Enabling the creation of dynamic, real-time Web applications; and

Providing the ability to create a wide variety of user interface components.

With JAVA, developers can create robust User Interface (UI) components. Custom “widgets” (e.g., real-time stock tickers, animated icons, etc.) can be created, and client-side performance is improved. Unlike HTML, JAVA supports the notion of client-side validation, offloading appropriate processing onto the client for improved performance. Dynamic, real-time Web pages can be created. Using the above-mentioned custom UI components, dynamic Web pages can also be created.

JAVA has emerged as an industry-recognized language for “programming the Internet.” JAVA is defined as: a simple, object-oriented, distributed, interpreted, robust, secure, architecture-neutral, portable, high-performance, multithreaded, dynamic, buzzword-compliant, general-purpose programming language. JAVA supports programming for the Internet in the form of platform-independent JAVA applets. JAVA applets are small, specialized applications that comply with the JAVA Application Programming Interface (API) allowing developers to add “interactive content” to Web documents (e.g., simple animations, page adornments, basic games, etc.). Applets execute within a JAVA-compatible browser (e.g., Netscape Navigator) by copying code from the server to client. From a language standpoint, JAVA's core feature set is based on C++.

Extending Type Attributes

Many preexisting VoiceXML elements such as <field> and <grammar> have a “type” attribute that controls the workings of such elements. For example, with respect to field, the type can be “boolean” or “date”, which controls whether the field accepts a “yes”/“no” response, or a date.

The present extension provides a way to extend the set of “type” attributes that a pre-defined element such as <field> accepts. One can register the tag name (i.e. “field”, “grammar”, etc.), the extended type attribute name (i.e. “country”, etc.), and the class to be loaded to implement that extended type attribute. Later, when the interpreter encounters the tag (i.e. <field type=“country”>), it may use the mapping to determine which code to use to implement the type attribute.

A system, method and computer program product are thus provided for dynamically extending a type attribute of elements of a voice-based extensible mark-up language (VoiceXML). Initially, an extended type attribute associated with an element of VoiceXML is registered with a VoiceXML interpreter. During use, the element may be received, and the extended type attribute associated with the element is identified. Thereafter, code corresponding to the registered type attribute may be accessed utilizing the VoiceXML interpreter. Such code extends the functionality of the VoiceXML.

As such, a data structure is provided for dynamically extending a type attribute of elements of a VoiceXML. First provided is a VoiceXML type attribute object that is extended to include a previously undefined type attribute. Also included is a VoiceXML element. Associated therewith is a class object for identifying a class to be loaded for the VoiceXML type attribute object that is extended. In use, the data structure is capable of being used to register type attributes capable of accessing code to extend the functionality of the VoiceXML.

### EXAMPLE

An example of the foregoing extension technique will now be set forth. Table 8 illustrates an exemplary data structure for registering an extended type attribute, “duration,” associated with the “field” element. This extension may be particular useful since it extends the basic types of what users can say.

TABLE 8

<bevocal:extend element=“field” type=“duration”
classid=“com.foo.vxml.mydate”
archive=“extensions.jar” />

Since such a type attribute is not supported by default, developers are thus provided with a way of adding the same. An example of how such extended field type attribute is added is shown in Table 9.

TABLE 9

<field type=“duration” name=“length”>

How long an appointment do you need?
. . .

</field>

It should be noted that various other type attributes may be supported including, but not limited to digits, number, phone, currency, equity, airline information, address, country, or any other functionality required by a voice portal.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for dynamically extending element types for a voice-based extensible mark-up language (VoiceXML), comprising:
(a) registering a plurality of element types with a VoiceXML interpreter;
(b) receiving the element types during use of the VoiceXML interpreter; and
(c) accessing code associated with the registered element types utilizing the VoiceXML interpreter;
(d) wherein the code extends the functionality of the VoiceXML.

2. The method as set forth in claim 1, wherein the code is written in JAVA.

3. The method as recited in claim 1, wherein the registration includes tagging the registered element types as being extensions to a conventional set of element types.

4. The method as recited in claim 3, wherein the element types are tagged utilizing extensible mark-up language (XML) namespaces.

5. The method as recited in claim 3, wherein the registration includes identifying a VoiceXML element type to be extended.

6. The method as recited in claim 5, wherein the registration includes identifying a name for the VoiceXML element type to be extended.

7. The method as set forth in claim 6, wherein the registration includes identifying a class to be loaded for the VoiceXML element type to be extended.

8. The method as set forth in claim 6, wherein the registration includes identifying a location of a file containing class files associated with the identified class.

9. The method as set forth in claim 1, wherein the VoiceXML interpreter is a component of a speech recognition/synthesis system available over the Internet.

10. A computer program product for dynamically extending element types for a voice-based extensible mark-up language (VoiceXML), comprising:
(a) computer code for registering a plurality of element types with a VoiceXML interpreter;
(b) computer code for receiving the element types during use of the VoiceXML interpreter; and
(c) computer code for accessing code associated with the registered element types utilizing the VoiceXML interpreter;
(d) wherein the code extends the functionality of the VoiceXML.

11. The computer program product as set forth in claim 10, wherein the code is written in JAVA.

12. The computer program product as recited in claim 10, wherein the registration includes tagging the registered element types as being extensions to a conventional set of element types.

13. The computer program product as recited in claim 13, wherein the element types are tagged utilizing extensible mark-up language (XML) namespaces.

14. The computer program product as recited in claim 13, wherein the registration includes identifying a VoiceXML element type to be extended.

15. The computer program product as recited in claim 14, wherein the registration includes identifying a name for the VoiceXML element type to be extended.

16. The computer program product as set forth in claim 15, wherein the registration includes identifying a class to be loaded for the VoiceXML element type to be extended.

17. The computer program product as set forth in claim 15, wherein the registration includes identifying a location of a file containing class files associated with the identified class.

18. The computer program product as set forth in claim 10, wherein the VoiceXML interpreter is a component of a speech recognition/synthesis system available over the Internet.

19. A system for dynamically extending element types for a voice-based extensible mark-up language (VoiceXML), comprising:
(a) logic for registering a plurality of element types with a VoiceXML interpreter;
(b) logic for receiving the element types during use of the VoiceXML interpreter; and
(c) logic for accessing code associated with the registered element types utilizing the VoiceXML interpreter;
(d) wherein the code extends the functionality of the VoiceXML.

20. A method for dynamically extending element types for a voice-based extensible mark-up language (VoiceXML), comprising:
(a) registering a plurality of element types with a VoiceXML interpreter utilizing a data structure including:
(i) a VoiceXML element type to be extended,
(ii) a name for the VoiceXML element type to be extended,
(iii) a class to be loaded for the VoiceXML element type to be extended, and
(iv) a location of a file containing class files associated with the identified class;
(b) tagging the registered element types as being extensions to a conventional set of element types, wherein the element types are tagged utilizing extensible mark-up language (XML) namespaces;
(c) receiving element types during use of the VoiceXML interpreter;
(d) determining whether the received element types are registered based on the tagging; and
(e) accessing code associated with the element types utilizing the VoiceXML interpreter if the received element types are determined to be registered;
(f) wherein the code extends the functionality of the VoiceXML.

21. A data structure stored in memory for dynamically extending element types for a voice-based extensible mark-up language (VoiceXML), comprising:
(a) a VoiceXML element type object for identifying a VoiceXML element type to be extended;
(b) a name object for identifying a name for the VoiceXML element type to be extended;
(c) a class object for identifying a class to be loaded for the VoiceXML element type to be extended; and
(d) a location object for identifying a location of a file containing class files associated with the identified class;
(e) wherein the data structure is capable of being used to register element types capable of accessing code to extend the functionality of the VoiceXML.

22. A method for dynamically extending a type attribute of elements of a voice-based extensible mark-up language (VoiceXML), comprising:
(a) registering with a VoiceXML interpreter an extended type attribute associated with an element of VoiceXML;
(b) receiving the element during use of the VoiceXML interpreter;
(c) identifying the extended type attribute associated with the element; and
(d) accessing code corresponding to the registered type attribute utilizing the VoiceXML interpreter;
(e) wherein the code extends the functionality of the VoiceXML.

23. A computer program product for dynamically extending a type attribute of elements of a voice-based extensible mark-up language (VoiceXML), comprising:
(a) computer code for registering with a VoiceXML interpreter an extended type attribute associated with an element of VoiceXML;
(b) computer code for receiving the element during use of the VoiceXML interpreter;
(c) computer code for identifying the extended type attribute associated with the element; and
(c) computer code for accessing code corresponding to the registered type attribute utilizing the VoiceXML interpreter;
(d) wherein the code extends the functionality of the VoiceXML.

24. A data structure stored in memory for dynamically extending a type attribute of elements of a voice-based extensible mark-up language (VoiceXML), comprising:
(a) a VoiceXML type attribute object that is extended to include a previously undefined type attribute;
(b) a VoiceXML element; and
(c) a class object for identifying a class to be loaded for the VoiceXML type attribute object that is extended;
(d) wherein the data structure is capable of being used to register VoiceXML type attribute objects capable of accessing code to extend the functionality of the VoiceXML.

25. The data structure as set forth in claim 24, wherein the element includes at least one of grammar and field.

26. The data structure as set forth in claim 24, wherein the type includes at least one of digits, number, phone, currency, equity, airline information, address, and country.
